(19) United States
(12) Patent Application Publication
(10) Pub. No.: US 2014/0038476 A1
(43) Pub. Date: Feb. 6, 2014

(54) CONNECTOR

(71) Applicants: Takao Kobayashi, Kanagawa (JP); Michiya Masuda, Kanagawa (JP)

(72) Inventors: Takao Kobayashi, Kanagawa (JP); Michiya Masuda, Kanagawa (JP)

(73) Assignee: NHK SPRING CO., LTD., Yokohama-shi (JP)

(21) Appl. No.: 14/112,348

(22) PCT Filed: Apr. 20, 2012
(86) PCT No.: PCT/JP12/60779

§ 371 Date: Oct. 17, 2013

(30) Foreign Application Priority Data
Apr. 21, 2011 (JP) 2011-095106

(51) Int. Cl. H01R 13/62

(52) U.S. Cl. CPC H01R 13/62
USPC 439/877

(57) ABSTRACT

A connector includes a first and a second terminals and a fixing member that fixes the first and the second terminals by covering periphery thereof in a state where the first and the second terminals are aligned in the direction extending into the rod-shape and overlap with each other in a direction perpendicular to the direction in which the first and the second terminals are aligned, wherein a cut-out portion of the first terminal faces a peripheral portion or a cut-out portion of the second terminal in the overlapping state, and at least parts of outer edges of a facing part have a same shape on the section along the direction perpendicular to the direction extending into the rod-shape.

### FIELD

The present invention relates to a connector that is interposed between two connection objects and establishes electrical continuity between the two connection objects.

### BACKGROUND

Conventionally, to connect electronic devices arranged in a vehicle or the like, widely used are connectors that are interposed between two connection objects and establish electrical continuity between, the two connection objects, thereby electrically connecting the devices. Such connectors electrically connect connection objects by bringing two terminals coupled to the respective connection objects into contact with each other.

Such connectors need to maintain, electrical connection between the electronic devices stably. To establish stable electrical continuity, there has been developed a connector including a cylindrical terminal having a hollow space and of which a part is formed of an elastic piece (an elastic blade or a sleeve), for example. The elastic piece presses the side surface of a cylindrical male terminal when the male terminal is housed in the hollow space of the cylindrical terminal, thereby connecting the terminals (refer to Patent literatures 1 and 2, for example).

### CITATION LIST

### Patent Literature

Patent Literature 1: Japanese Translation of PCT Application Publication No. 2010-538430

Patent Literature 2: Japanese Patent Application Laid-open No. 2008-103153

### SUMMARY

### Technical Problem

A connector mounted on a vehicle or the like needs to establish electrical continuity stably even when a high electric current flows. To achieve this, the contact resistance between the terminals may be reduced. The conventional connectors disclosed in Patent literatures 1 and 2, however, may possibly increase the contact resistance because of difference in the pressing force of the female terminal (elastic piece) against the male terminal and reduction in the biasing force of the elastic piece caused by energization heat.

In view of the problems described above, it is an object of the present invention to provide a connector that can reduce contact resistance between terminals, thereby establishing stable and efficient electrical continuity.

### Solution to Problem

To solve the problem described above and achieve the object, a connector for being interposed between two connection objects and establishing electrical continuity between the two connection objects according to the present invention includes: a first terminal having conductivity and extending in a rod-shape, comprising a first peripheral portion serving as a peripheral surface of the rod-shape and a first cut-out portion obtained by cutting out whole or a part of the rod-shape from an end opposite to an end for being coupled to one of the two connection objects in a direction extending into the rod-shape; a second terminal having conductivity and extending in a rod-shape, comprising a second peripheral portion serving as a peripheral surface of the rod-shape and a second cut-out portion obtained by cutting out whole or a part of the rod-shape from an end opposite to an end for being coupled to another one of the two connection objects in a direction extending into the rod-shape and having a same cut-out shape as that of the first cut-out portion on a section along a direction perpendicular to the direction extending into the rod-shape; and a fixing member that fixes the first terminal and the second terminal by covering periphery of the first and the second terminals in a state where the first terminal and the second terminal are aligned in the direction extending into the rod-shape and overlap with each other in a direction perpendicular to the direction in which the first and the second terminals are aligned, wherein the first cut-out portion faces the second peripheral portion or the second cut-out portion in the state where the first terminal and the second terminal overlap with each other, and at least parts of outer edges of a facing part have a same shape on the section along the direction perpendicular to the direction extending into the rod-shape.

Moreover, in the above-described connector according to the present invention, the first cut-out portion and the second cut-out portion make contact with each other in the state where the first terminal and the second terminal overlap with each other.

Moreover, in the above-described connector according to the present invention, the first cut-out portion has a linear shape or a convex-concave shape on the section along the direction perpendicular to the direction extending into the rod-shape.

Moreover, in the above-described connector according to the present invention, a sectional shape of the periphery formed of the first terminal and the second terminal of the facing part in the state where the first terminal and the second terminal overlap with each other is a figure having rotational symmetry through a rotation angle θ (0°<θ<360°, θ is a constant).

Moreover, in the above-described connector according to the present invention, the figure is a circle.

Moreover, in the above-described connector according to the present invention, at least a part of an outer edge of the first cut-out portion on the section along the direction perpendicular to the direction extending into the rod-shape has a same shape as that of an outer edge of the second cut-out portion on the section, and the first cut-out portion and the second peripheral portion make contact with each other in the state where the first terminal and the second terminal overlap with each other.

Moreover, in the above-described connector according to the present invention, the first cut-out portion or the first peripheral portion has a groove formed in the direction extending into the rod-shape on a surface thereof.

Moreover, in the above-described connector according to the present invention, the fixing member is formed of an elastic body that applies bias toward at least the facing part of the first terminal and the second terminal in a direction in which the first terminal and the second terminal overlap with each other.

Moreover, in the above-described connector according to the present invention, the first terminal and the second terminal have a same shape.

### Advantageous Effects of Invention

A connector according to the present invention brings two terminals into contact with each other on respective parts having the same outer-edge shape on a section. Thus, the connector can reduce the contact resistance between the terminals, thereby establishing stable and efficient electrical continuity.

### BRIEF DESCRIPTION OF DRAWINGS

FIG. 1 is a perspective view schematically illustrating a structure of a connector according to a first embodiment of the present invention.

FIG. 2 is a side view schematically illustrating the structure of the connector according to the first embodiment of the present invention.

FIG. 3 is a perspective view schematically illustrating a structure of a terminal of the connector according to the first embodiment of the present invention.

FIG. 4 is a view of the structure of the terminal illustrated in FIG. 3.

FIG. 5 is a sectional view of the terminal along line A-A in FIG. 4

FIG. 6 is a sectional view of the terminal along line B-B in FIG. 4.

FIG. 7 is a sectional view of the connector along line C-C in FIG. 2.

FIG. 8 is a sectional view of a connector according to a first modification of the first embodiment of the present invention.

FIG. 9 is a sectional view of a connector according to a second modification of the first embodiment of the present invention.

FIG. 10 is a side view of a connector according to a third modification of the first embodiment of the present invention.

FIG. 11 is a perspective view of a connector according to a fourth modification of the first embodiment of the present invention.

FIG. 12 is a perspective view schematically illustrating a structure of a connector according to a second embodiment of the present invention.

FIG. 13 is a side view schematically illustrating the structure of the connector according to the second embodiment of the present invention.

FIG. 14 is a sectional view of the connector along line E-E in FIG. 13.

FIG. 15 is a view schematically illustrating a structure of a terminal of the connector according to the second embodiment of the present invention.

FIG. 16 is a sectional view of a connector according to a first modification of the second embodiment of the present invention.

FIG. 17 is a sectional view of a connector according to a second modification of the second embodiment of the present invention.

FIG. 18 is a schematic of an outline of a contact resistance comparative test.

FIG. 19 is a graph indicating the relation between an applied load and contact resistance in the contact resistance comparative test.

FIG. 20 is a sectional view of a connector according to a third modification of the second embodiment of the present invention.

FIG. 21 is a sectional view of a connector according to a fourth modification of the second embodiment of the present invention.

FIG. 22 is a perspective view of a connector according to a third embodiment of the present invention.

FIG. 23 is a view schematically illustrating a structure of a terminal of the connector according to the third embodiment of the present invention.

### DESCRIPTION OF EMBODIMENTS

Exemplary embodiments according to the present invention are described below in greater detail with reference to the accompanying drawings. The embodiments are not intended to limit the present invention. The drawings referred to in the description below schematically illustrate shapes, sizes, and positional relations so as to enable grasping the contents of the present invention. The present invention is not limited to the shapes, the sizes, and the positional relations illustrated in the drawings.

### First Embodiment

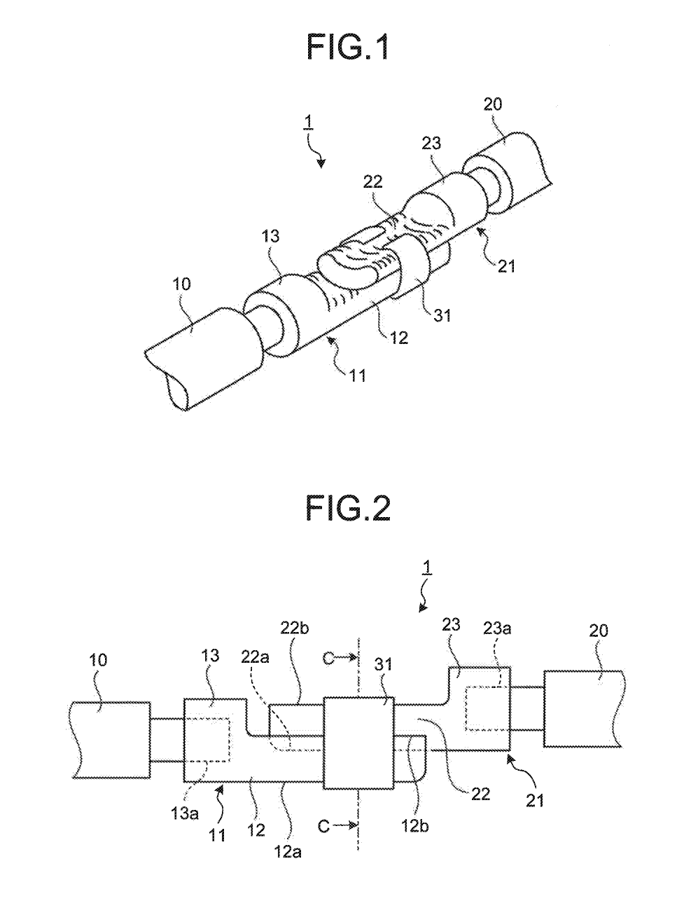

FIG. 1 is a perspective view schematically illustrating a structure of a connector 1 according to a first embodiment. FIG. 2 is a side view schematically illustrating the structure of the connector according to the first embodiment. The connector 1 illustrated in FIGS. 1 and 2 establishes electric continuity between connection objects by bringing terminals coupled to the respective connection objects into contact with each other.

The connector 1 includes a terminal 11 serving as a first terminal having conductivity, extending into a rod-shape, and coupled to a conductor 10 which is one connection object, a terminal 21 serving as a second terminal having conductivity, extending into a rod-shape, and coupled to a conductor 20 which is another connection object, and a fixing member 31 that fixes the terminals 11 and 21 by covering the periphery of a contact part of the terminal 11 and the terminal 21 such that the terminal 11 and the terminal 21 are aligned in the direction extending into the rod-shape and overlap with each other in a direction perpendicular to the direction in which the terminals 11 and 21 are aligned. The conductor 10 and the conductor 20 are formed of a plurality of power lines covered with an insulating resin, for example.

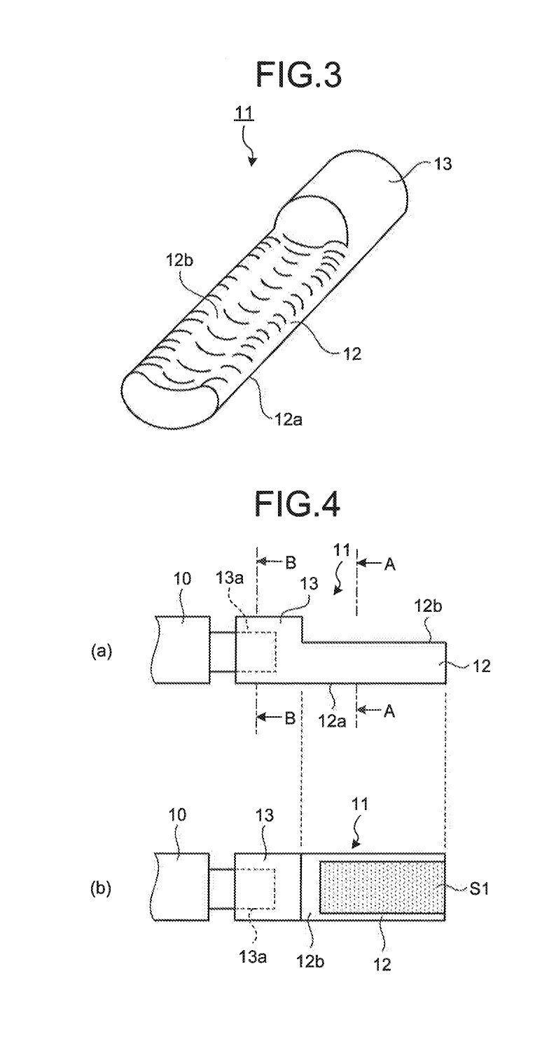

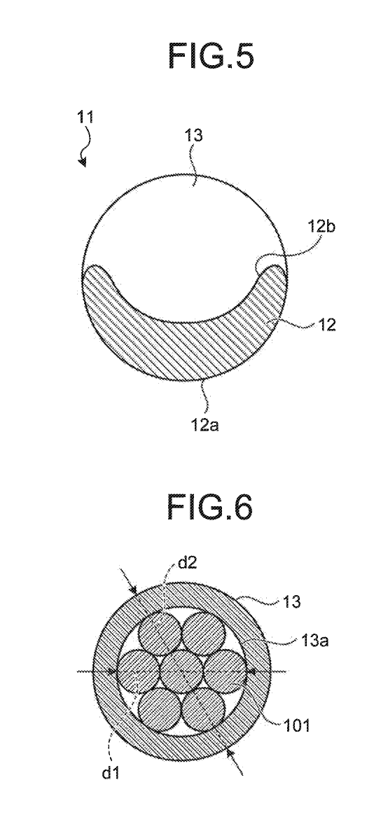

FIG. 3 is a perspective view schematically illustrating the structure of the terminal of the connector according to the first embodiment of the present invention. FIG. 4 includes a side view (a) and a top view (b) of the structure of the terminal 11 illustrated in FIG. 3. FIG. 5 is a sectional view of the terminal 11 along line A-A in FIG. 4. FIG. 6 is a sectional view of the terminal 11 along line B-B in FIG. 4. The terminal 11 is produced by cutting out a part of a conductive material formed in a rod-shape from an end opposite to the end coupled to the conductor 10 in the direction extending into the rod-shape. The terminal 11 includes a contact portion 12 that makes contact with the terminal 21 and a base 13 connecting with the contact portion 12 and coupled to the conductor 10.

The contact portion 12 includes a peripheral portion 12a serving as a first peripheral portion, which is a peripheral surface of the rod, and a cut-out portion 12b serving as a first cut-out portion cut in a recessed shape on a section along a direction perpendicular to the direction extending into the rod-shape.

As illustrated in FIG. 5, the cut-out portion 12b has a recessed (arc) section. The radius of curvature of the outer edge of the cut-out portion 12b having the recessed shape is equal to that of the outer edge of the peripheral portion 12a on the same section.

The base 13 has a housing hole 13a forming an approximately columnar hollow space along the direction in which the terminal 11 extends. As illustrated in the sectional view of FIG. 6, the diameter of the hollow space in a direction perpendicular to the direction in which the terminal 11 extends is equal to or larger than a maximum diameter d1 of a plurality of power lines 101 that are bundled. Housing the power lines 101 in the hollow space of the housing hole 13a can electrically connect the terminal 11 and the conductor 10. Caulking (plastic deformation or the like) performed from the periphery of the base 13 presses the wall surface of the housing hole 13a against the power lines 101, thereby fixing the power lines 101 and the housing hole 13a.

The terminal 21 has the same shape as that of the terminal 11. The terminal 21 includes a contact portion 22 that makes contact with the terminal 11 and a base 23 connecting with the contact portion 22 and coupled to the conductor 20. The contact portion 22 includes a peripheral portion 22a serving as a second peripheral portion, which is a peripheral surface of the rod, and a cut-out portion 22b serving as a second cut-out portion cut in a recessed shape on a section along a direction perpendicular to the direction extending into the rod-shape. The base 23 has a housing hole 23a forming an approximately columnar hollow space along the direction in which the terminal 21 extends and housing a plurality of power lines of the conductor 20 in the hollow space.

The terminals 11 and 21 are made of a pure copper material serving as a conductive material. The terminals 11 and 21 are formed by cutting a rod member made of pure copper and having the same diameter as those of the bases 13 and 23 such that the contact portions 12 and 22 have predetermined sections, respectively, for example. The cut-out surfaces formed by the cutting correspond to the cut-out portions 12b and 22b.

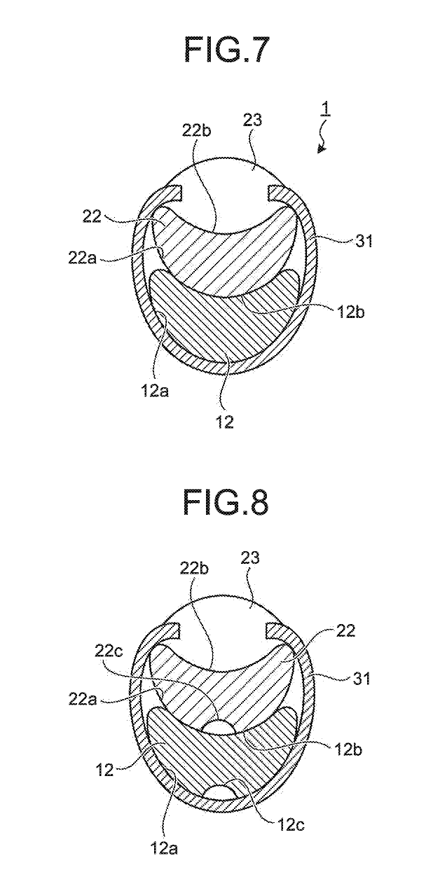

The fixing member 31 is formed by curving a plate-shaped carbon tool steel or stainless steel into an approximately ring shape along the plate surface. As illustrated in the sectional view of FIG. 7, the fixing member 31 has an approximately elliptical shape whose center part has a radius of curvature equal to that of the peripheral portion 12a of the terminal 11 or the peripheral portion 22a of the terminal 21. The radius of curvature at an end of the fixing member 31 is smaller than the other partial radii of curvature. The fixing member 31 fixes the contact portions 12 and 22 by applying bias toward at least the contact part of the contact portions 12 and 22 in the state where the contact portions 12 and 22 overlap with each other in a direction perpendicular to the direction in which the terminals 11 and 21 extend. Any type of fixing member may be used as long as it is an elastic body that can fix the contact portions 12 and 22 by applying bias toward at least the contact part of the contact portions 12 and 22.

As illustrated in FIGS. 1, 2, and 7, the connector 1 aligns the contact portions 12 and 22 in the direction in which the terminals 11 and 21 extend and causes the contact portions 12 and 22 to overlap with each other in the direction perpendicular to the direction in which the contact portions 12 and 22 are aligned, thereby electrically connecting the terminal 11 and the terminal 21. At this time, the cut-out portion 12b and the peripheral portion 22a of the terminals 11 and 21, respectively, are in contact with each other. Because the radius of curvature of the outer edge of the cut-out portion 12b is equal to that: of the outer edge of the peripheral portion 22a, the cut-out portion 12b and the peripheral portion 22a are in surface-contact with each other. The contact portion 12 of the terminal 11 makes contact with the contact portion 22 in a contact area S1 illustrated in FIG. 4(b).

Given that Sa represents the area of the contact area S1 illustrated in FIG. 4 on the contact surface of the terminals 11 and 21 in the connector 1, and Sb represents the sum of the sectional areas of the power lines 101 on the sectional area illustrated in FIG. 6, the relation between the area Sa of the contact area S1 and the sum Sb of the sectional areas of the power lines 101 can be expressed by Sa≧Sb. The relation can reduce the contact resistance between the terminals 11 and 21, thereby establishing stable and efficient electrical continuity.

In the sectional view of FIG. 6, a diameter d2 of the base 13 is larger than the maximum diameter d1 of the power lines 101 thus bundled. Given that Sc represents the sectional area of the section of the contact portion 12 illustrated in FIG. 5, the sectional area Sc can be made nearly equal to the sum Sb of the sectional areas of the power lines 101. This can reduce the energization resistance between the terminals 11 and 21. An assumption is made that the sum Sb of the sectional areas is 20 mm² (the maximum diameter d1 is 5.0 mm), for example. To make the sectional area Sc 20 mm², the diameter d2 of the base 13 simply needs to be set to approximately 7.1 mm. Thus, it is not necessary to set the diameter d2 of the base 13 to an extremely large value with respect to the maximum diameter d1 of the power lines 101.

The first embodiment brings two terminals having the same shape into contact with each other on respective parts having the outer-edge shape with the same radius of curvature on the section. This can increase the contact surface area to reduce the contact resistance between the terminals, thereby establishing stable and efficient electrical continuity.

Because the first embodiment can provide a connector using the terminals having the same shape, it is not necessary to produce a male terminal and a female terminal individually as in the conventional technology. Thus, the first embodiment can also reduce a manufacturing process and manufacturing cost.

While the first embodiment describes the case where the terminals have the same shape, the terminals may have at least the same sectional (outer-edge) shape of the contact part. Furthermore, the lengths of the respective contact portions in the direction in which the terminals extend may be different from each other as long as they can secure the area Sa of the contact area S1.

FIG. 8 is a sectional view of a connector according to a first modification of the first embodiment. The sectional view corresponds to the section along line C-C in FIG. 2. The first modification has grooves 12c and 22c formed in the peripheral portions 12a and 22a of the contact portions 12 and 22, respectively, as illustrated in the sectional view of FIG. 8. The grooves 12c and 22c are formed in the peripheral portions 12a and 22a in the direction in which the terminals 11 and 21 extend, respectively.

While the first embodiment describes the case where the radius of curvature of the peripheral portion is equal to that of the cut-out portion, the radii, of curvature may possibly be slightly different from each other because of surface precision in manufacturing or other factors. In this case, the difference in the radius of curvature between the peripheral portion and the cut-out portion causes the contact portions 12 and 22 to make contact with each other not on a line but on a point on the section illustrated in FIG. 7. As a result, the contact area is reduced. By contrast, when the first modification brings the contact portions 12 and 22 into contact with each other, the grooves 12c and 22c do not make contact with each other, but the contact portions 12 and 22 make contact with each other not on a point on the section. The first modification brings the contact portions 12 and 22 into surface-contact with each other on both sides of the groves, thereby securing the contact surface area.

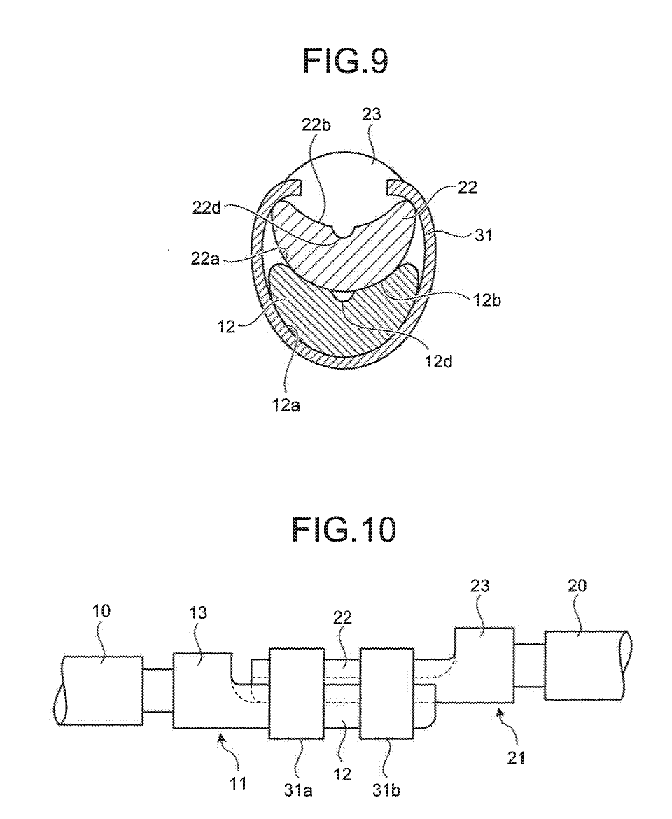

FIG. 9 is a sectional view of a connector according to a second modification of the first embodiment of the present invention. As illustrated in the second modification of FIG. 9, grooves 12d and 22d may be formed in the cut-out portions 12b and 22b, respectively. Also in the second modification, the grooves 12d and 22d are formed in the cut-out portions 12b and 22b in the direction in which the terminals 11 and 21 extend, respectively. The second modification can provide the same advantageous effects as those of the first modification.

FIG. 10 is a side view of a connector according to a third modification of the first embodiment. The third modification fixes the terminals by covering the periphery of the contact part of the terminals using a plurality of fixing members (two fixing members in the present modification) 31a and 31b. The fixing positions of the fixing members 31a and 31b can be set arbitrarily.

The length (width) of the fixing member in a direction perpendicular to the curving direction can be adjusted. The width can be set equal to the length of the contact area S1 illustrated in FIG. 4(b) in the direction in which the terminal 11 extends, for example. In the case were the lengths of the contact portions of the respective terminals are different in the direction in which the terminals extend into the rod-shape, the width can be set equal to the length of the contact portion having the shorter length. By increasing the width of the fixing member depending on the contact area and the contact portion to cover the contact part, it is possible to suppress rotation of the terminals against a load applied to the terminals in a direction separating the contact portions in a contact state, thereby maintaining the contact state of the terminals.

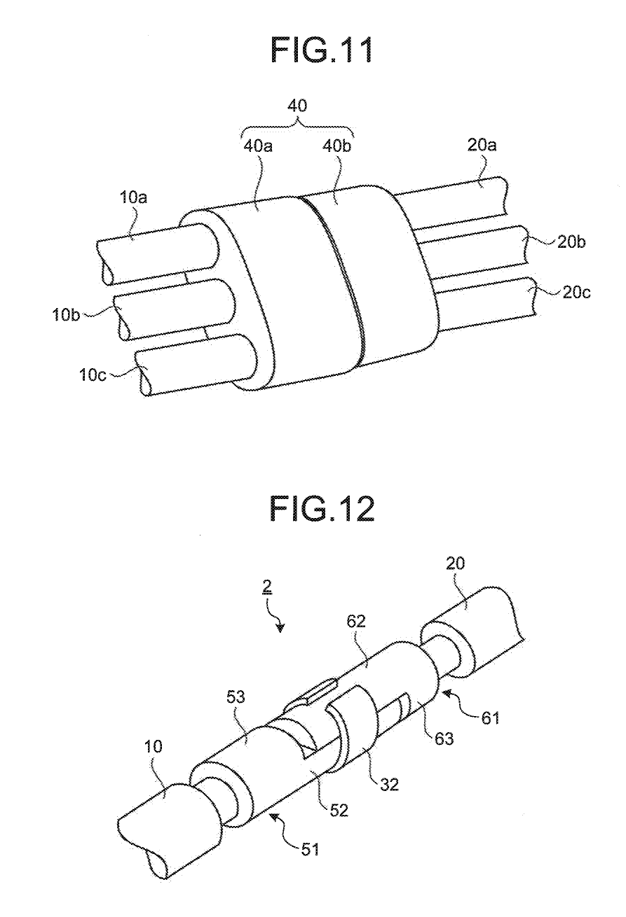

FIG. 11 is a perspective view of a connector according to a fourth modification of the first embodiment. The fourth modification uses a housing case 40 to bundle a plurality of conductors connected by the connector. Specifically, the housing case 40 includes a first housing case 40a housing three terminals 11 in parallel and a second housing case 40b housing three terminals 21 in parallel. The respective terminals 11 are coupled to three conductors 10a to 10c. The respective terminals 21 are coupled to three conductors 20a to 20c.

The first housing case 40a and the second housing case 40b house the terminals 11 and the terminals 21, respectively, such that the contact portions 12 (cut-out portions 12b) and the contact portions 22 (peripheral portions 22a) can snake contact with each other on the side surfaces on the coupling side when the first housing case 40a and the second housing case 40b are coupled. The housing case 40 can maintain the contact state of the terminals and cover the contact part of the terminals. Thus, it is possible to maintain the connection state of the terminals more reliably besides to protect the terminals.

### Second Embodiment

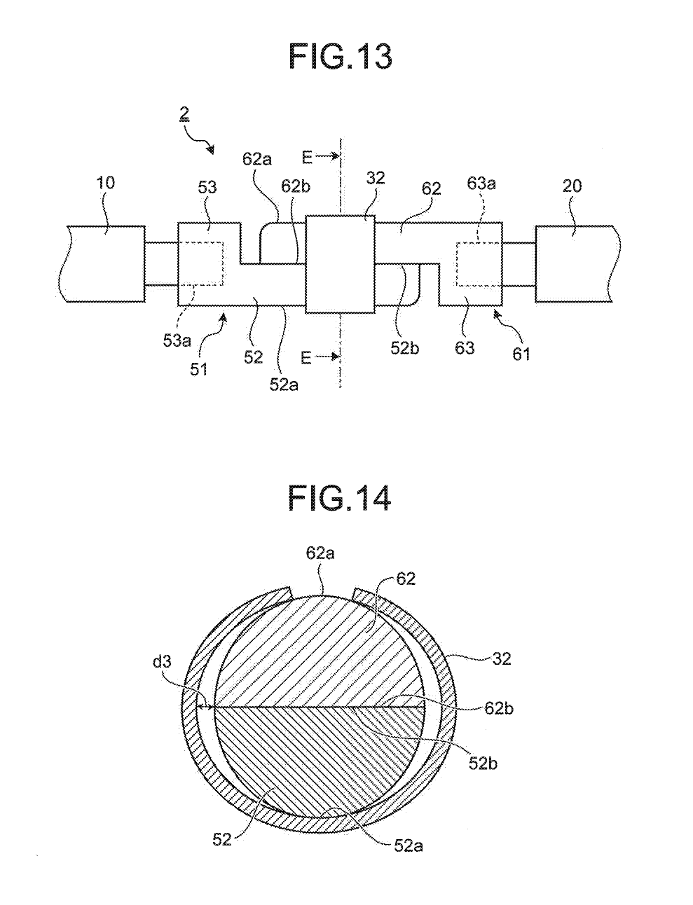

A second embodiment according to the present invention will now be described with reference to FIG. 12 to FIG. 14. FIG. 12 is a perspective view schematically illustrating a structure of a connector according to the second embodiment of the present invention. FIG. 13 is a side view schematically illustrating the structure of the connector according to the second embodiment of the present invention. FIG. 14 is a sectional view of the connector along line E-E in FIG. 13. A connector 2 illustrated in FIG. 12 to FIG. 14 brings terminals coupled to respective connection objects into contact with each other and connects the terminals, thereby establishing electrical continuity between the connection objects. Components similar to those of the connector described with reference to FIG. 1 and other drawings are represented by similar reference numerals.

The connector 2 includes a terminal 51 serving as a first terminal extending into a rod-shape, coupled to a conductor 10, and having conductivity, a terminal 61 serving as a second terminal extending into a rod-shape, coupled to a conductor 20, and having conductivity, and a fixing member 32 that fixes the terminals 51 and 61 by covering the periphery of a contact part of the terminal 51 and the terminal 61 such that the terminal 51 and the terminal 61 are aligned in the direction extending into the rod-shape and overlap with each other in a direction perpendicular to the direction in which the terminals 51 and 61 are aligned.

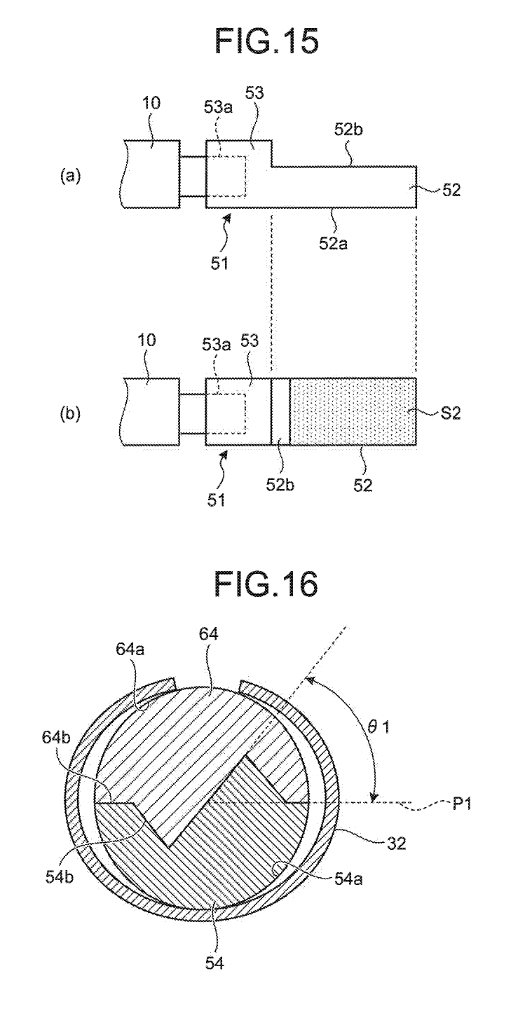

FIG. 15 includes a side view (a) and a top view (b) of the structure of the terminal 51 of the connector according to the second embodiment. The terminal 51 is produced by cutting out a part of a conductive material formed in a rod-shape from an end opposite to the end coupled to the conductor 10 in the direction extending into the rod-shape. The terminal 51 has a semicircular shape on a section along a direction perpendicular to the direction in which the terminal 51 extends (refer to FIG. 14). The terminal 51 includes a contact portion 52 that makes contact with the terminal 61 and a base 53 connecting with the contact portion 52 and coupled to the conductor 10. The contact portion 52 includes a peripheral portion 52a serving as a first peripheral portion, which is a peripheral surface (an arc part) of the rod, and a cut-out portion 52b serving as a first cut-out portion cut in a linear shape on the section along the direction perpendicular to the direction extending into the rod-shape.

The base 53 has a housing hole 53a forming an approximately columnar hollow space along the direction in which the terminal 51 extends and housing a plurality of power lines 101 in the hollow space. Caulking (plastic deformation or the like) performed from the periphery of the base 53 presses the wall surface of the housing hole 53a against the power lines 101, thereby fixing the power lines 101 and the housing hole 53a.

The terminal 61 has the same shape as that of the terminal 51. The terminal 61 includes a contact portion 62 that makes contact with the terminal 51 and a base 63 connecting with the contact portion 62 and coupled to the conductor 20. The contact portion 62 includes a peripheral portion 62a serving as a second peripheral portion, which is a peripheral surface (an arc part) of the rod, and a cut-out portion 62b serving as a second cut-out portion out in a linear shape on a section along the direction perpendicular to the direction extending into the rod-shape. The base 63 has a housing hole 63a forming an approximately columnar hollow space along the direction extending into the rod-shape and housing a plurality of power lines of the conductor 20 in the hollow space.

Similarly to the terminals 11 and 21, the terminals 51 and 61 are made of pure copper serving as a conductive material. The terminals 51 and 61 are formed by cutting a rod member made of pure copper and having the same diameter as those of the bases 53 and 63 so as to have a semicircular shape on the section along the direction perpendicular to the direction extending into the rod-shape at positions to be the contact portions 12 and 22, respectively, for example. The cut-out surfaces formed by the cutting correspond to the cut-out portions 52b and 62b.

The fixing member 32 is formed by curving a plate-shaped carbon tool steel or stainless steel into an approximately ring shape along the plate surface. As illustrated in the sectional view of FIG. 14, the fixing member 32 has an approximately elliptical shape whose center part has a radius of curvature equal to that of the peripheral portion 52a or the peripheral portion 62a. The radius of curvature at an end of the fixing member 32 is smaller than the other partial radii of curvature. The fixing member 32 fixes the contact portions 52 and 62 by applying bias toward at least the contact part of the contact portions 52 and 62 such that the contact portions 52 and 62 overlap with each other in the direction perpendicular to the direction extending into the rod-shape.

The fixing member 32 and the contact portion 52 (62) are arranged away from each other by a distance d3 near a contact part of the fixing member 32 and the contact portions 52 and 62. Arrangement of the fixing member 32 and the contact portion 52 (62) away from each other near the contact part can suppress a frictional force between the fixing member 32 and the contact portion 52 (62) near the contact part. This can suppress reduction in the biasing force in the contact direction (direction perpendicular to the contact surfaces of the contact portions), thereby maintaining the contact state of the contact portions snore reliably.

As illustrated in FIGS. 12 to 14, the connector 2 aligns the contact portions 52 and 62 in the direction in which the terminals 51 and 61 extend and causes the contact portions 52 and 62 to overlap with each other in the direction perpendicular to the direction in which the contact portions 52 and 62 are aligned, thereby electrically connecting the terminal 51 and the terminal 61. At this time, the cut-out portion 52b and the cut-out portion 62b of the terminals 51 and 61, respectively, are in contact with each other. In the state where the contact portions 52 and 62 are in contact with each other, a sectional shape of the periphery formed of the contact portions 52 and 62 is a figure (a circle) having rotational symmetry through a rotation angle θ (0°<θ<360°, θ is a constant). Because the sections of the cut-out portion 52b and the cut-out portion 62b are formed in a linear shape, the cut-out portion 52b and the cut-out portion 62b are in surface-contact with each other. The contact portion 52 of the terminal 51 makes contact with the contact portion 62 in a contact area S2 illustrated in FIG. 15(b).

Similarly to the first embodiment, given that Sd represents the area of the contact area S2 on the contact surface of the terminals 51 and 61 in the connector 2, and Sc represents the sum of the sectional areas of the power lines on the section of the base 53 as in the section illustrated in FIG. 6, the relation between the area Sd of the contact area S2 and the sum Se of the sectional areas of the power lines can be expressed by Sd≧Se also in the second embodiment. The relation can reduce the contact resistance between the terminals 51 and 61, thereby establishing stable and efficient electrical continuity.

The second embodiment brings two terminals having the same shape into contact with each other on respective parts having the same outer-edge shape on the section. This can increase the contact surface area to reduce the contact resistance between the terminals, thereby establishing stable and efficient electrical continuity. Because the second embodiment can provide a connector using the terminals having the same shape, it is not necessary to produce a male terminal and a female terminal individually as in the conventional technology. Thus, the second embodiment can also reduce a manufacturing process and manufacturing cost.

Because the second embodiment brings the flat surfaces having a linear shape on the section into contact with each other, it is possible to bring the contact portions into contact with each other more easily and reliably than the case of surfaces having an arc shape.

While the second embodiment describes the case where the sections of the cut-out portions 52b and 62b along the direction perpendicular to the direction extending into the rod-shape have a linear shape, the sections may have a wave shape.

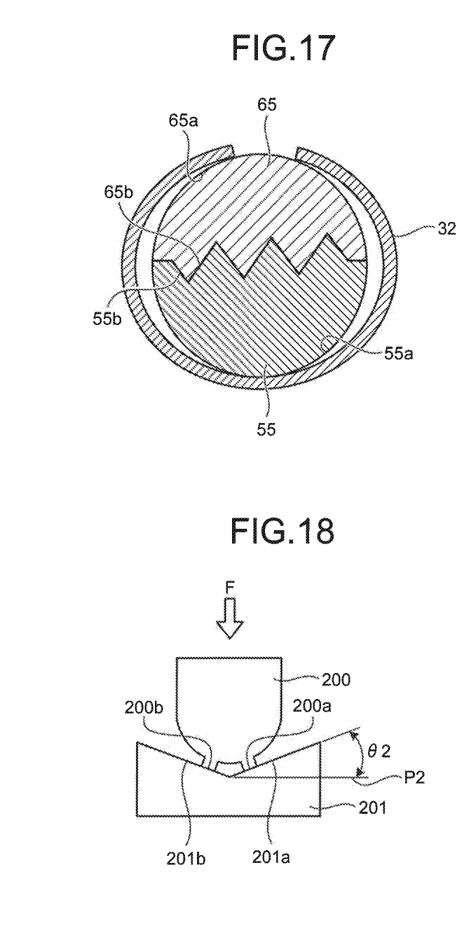

FIG. 16 is a sectional view of a connector according to a first modification of the second embodiment. FIG. 17 is a sectional view of a connector according to a second modification of the second embodiment. The sections illustrated in FIGS. 16 and 17 correspond to the section along line E-E in FIG. 13.

In the first modification illustrated in FIG. 16, the sections of cut-out portions 54b and 64b have a wave shape including a pair of convex-concave parts on the sections of contact portions 54 and 64 having the same shape. The outer edges of the cut-out portions 54b and 64b on the section have a wave shape inclined at an angle θ1 with respect to a plane P1. The plane P1 corresponds to the outer edges of the cut-out portions 52b and 62b illustrated in FIG. 14. In the state where the contact portions 54 and 64 are in contact with each other (overlap with each other), the outer edges of the contact portions 54 and 64 (periphery portions 54a and 64a) form a circle on the section.

In the second modification illustrated in FIG. 17, cut-out portions 55b and 65b have a wave shape including a plurality of pairs of convex-concave parts on the sections of contact portions 55 and 65 having the same shape. Also in this case, the outer edges of the cut-out portions 55b and 65b on the section have a wave shape inclined at a predetermined angle with respect to a plane corresponding to the outer edges of the cut-out portions 52b and 62b. In the state where the contact portions 55 and 65 are in contact with each other (overlap with each other), the outer edges of the contact portions 55 and 65 (periphery portions 55a and 65a) form a circle on the section.

Forming the sections of the cut-out portions in a wave shape as described in the first and the second modifications can make the contact area of the cut-out portions larger than that of the configuration of the second embodiment illustrated in FIG. 12 and other drawings. This can reduce the contact resistance between the terminals, thereby establishing more stable and efficient electrical continuity.

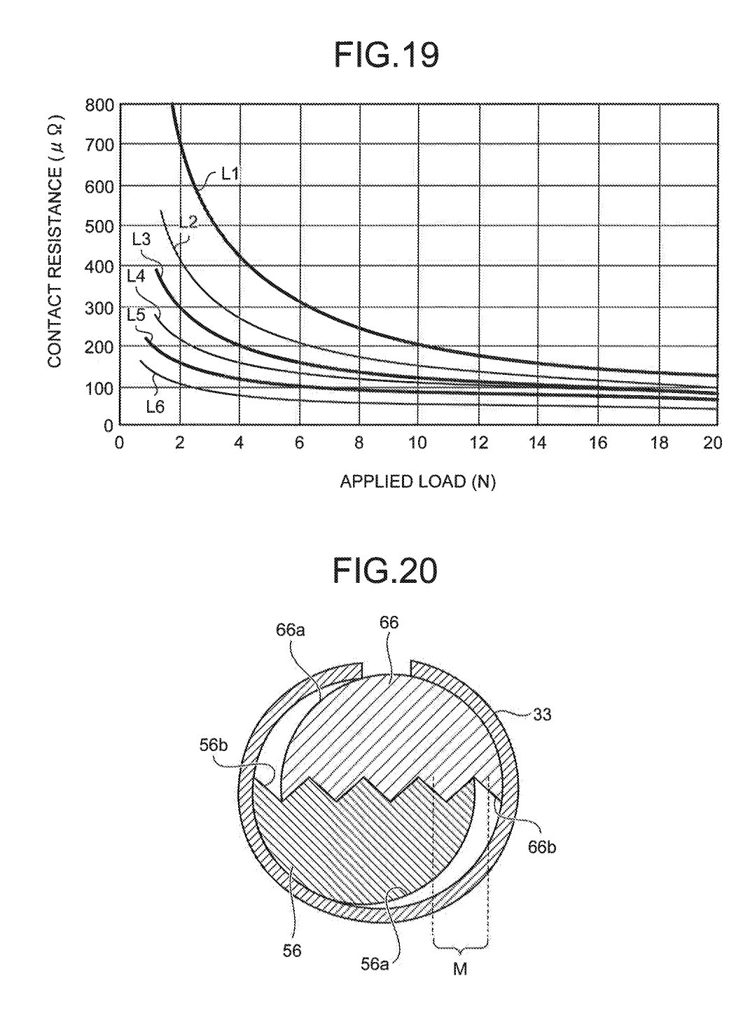

The first and the second modifications can further reduce the contact resistance value compared with the shapes of the cut-out portions 52b and 62b according to the second embodiment illustrated in FIG. 12 and other drawings. FIG. 18 is a schematic of an outline of a contact resistance comparative test. FIG. 19 is a graph indicating the relation between an applied load and contact resistance (μΩ) in the contact resistance comparative test. As illustrated in FIG. 18, test pieces 200 and 201 are used to measure the contact resistance therebetween in the contact resistance comparative test. The test piece 200 has protruding portions 200a and 200b that make contact with inclined portions 201a and 201b, respectively, of the test piece 201. An inclination angle θ2 of the inclined portions 201a and 201b with respect to a plane P2 was set to 0°, 10°, 20′, 40°, 60°, and 75°. The contact resistance between the test pieces 200 and 201 with respect to an applied load F was measured at each inclination angle θ2 in the contact resistance comparative test. The contact area of the protruding portions 200a and 200b and the inclined portions 201a and 201b, respectively, is set constant (the same contact area) independently of the inclination angle θ2.

In FIG. 19, a curve L1 represents the relation between an applied load and contact resistance in the case where the θ2 is set to 0°, a curve L2 represents the relation in the case where θ2 is set to 10°, a curve L3 represents the relation in the case where θ2 is set to 20°, a curve L4 represents the relation in the case where θ2 is set to 40°, a curve L5 represents the relation in the case where θ2 is set to 60°, and a curve L6 represents the relation in the case where θ2 is set to 75°. It is found that a larger applied load F reduces the contact resistance and that a larger inclination angle θ2 reduces the contact resistance between the test pieces.

Because of the relation between the inclination angle and the contact resistance, the cut-out portions having a wave shape according to the first and the second modifications can further reduce the contact resistance compared with the shapes of the cut-out portions 52b and 62b cut in a linear shape (corresponding to the plane P2).

While the second embodiment and the first and the second modifications describe the case where the outer edges of the contact portions (periphery portions) form a circle on the section in the state where the contact portions are in contact with each other (overlap with each other), the shape of the outer edges is not limited thereto.

FIG. 20 is a sectional view of a connector according to a third modification of the second embodiment. In the third modification illustrated in FIG. 20, cut-out portions 56b and 66b have a wave shape including a plurality of pairs of convex-concave parts on the sections of contact portions 56 and 66 having the same shape. In the state where the contact portions 56 and 66 are in contact with each other (overlap with each other), the cut-out portions 56b and 66b are in contact with each other with the end positions thereof misaligned. Specifically, assume that a pair of convex-concave parts M corresponds to one period in the convex-concave parts forming the wave shape on the section, the cut-out portions 56b and 66b overlap with each other in a manner misaligned by one-half period. At this time, the ends of the outer edges of the contact portions 56 and 66 (peripheral portions 56a and 66a) are not in contact with each other on the section. Similarly to the fixing members 31 and 32, a fixing member 33 is formed of an elastic body curved into an approximately ring shape along its plate surface and fixes the contact portions 56 and 66 by applying bias toward at least the contact part of the contact portions 56 and 66. In this case, the cut-out portions 56b and 66b overlap with each other in a manner misaligned by one-half period. The biasing force of the fixing member 33 applies a load so as to press the surfaces of the cut-out portions 56b and 66b against each other, thereby maintaining the contact state.

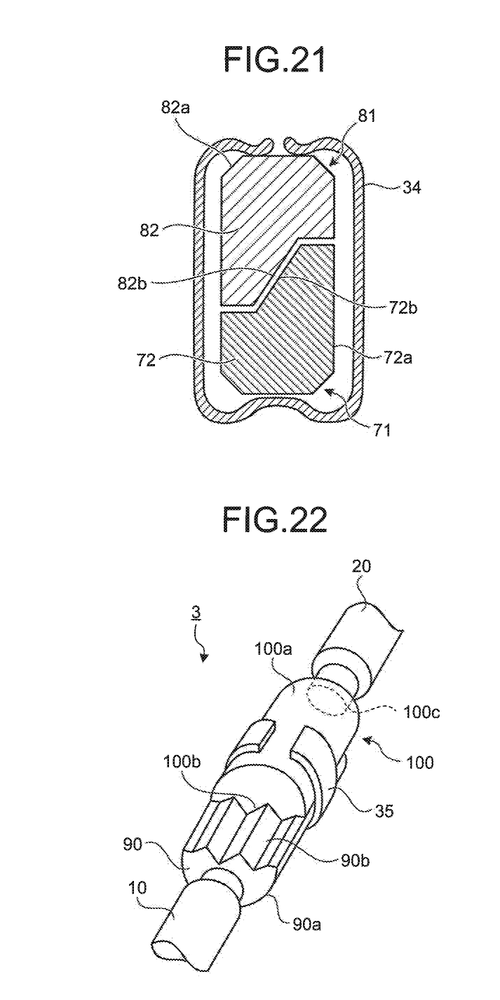

FIG. 21 is a sectional view of a connector according to a fourth modification of the second embodiment. In the fourth modification illustrated in FIG. 21, contact portions 72 and 82 of terminals 71 and 81 having the same shape include cut-out portions 72b and 82b, respectively, cut in a partially inclined shape on a section along the direction perpendicular to the direction extending into the rod-shape. In the state when the contact portions 72 and 82 are in contact with each other (overlap with each other), the outer-edge shape of the contact portions 72 and 82 (peripheral portions 72a and 82a) on the section is a polygon which is a figure having rotational symmetry through a rotation angle θ (0°<θ<360°, θ is a constant).

A fixing member 34 has an approximately rectangular ring shape and fixes the terminals 71 and 81 by covering the periphery of a contact part of the terminal 71 and the terminal 81 such that the terminal 71 and the terminal 81 overlap with each other in a direction perpendicular to the direction extending in the rod-shape. In the fixing member 34, the ends are curved toward the inner circumference, and a part opposite to the ends is curbed in a manner protruding toward the inner circumference. The fixing member 34 holds the contact portions 72 and 82 with the ends and the protruding part and applies bias toward at least the contact part of the contact portions 72 and 82.

Similarly to the terminals 11 and 21, the terminals 71 and 81 are made of pure copper serving as a conductive material. The terminals 71 and 81 are formed by cutting a rod member made of pure copper and having a polygonal shape on a section along the direction perpendicular to the direction extending into the rod-shape so as to have a predetermined shape on the section along the direction perpendicular to the direction extending into the rod-shape at the positions of the contact portions 72 and 82, respectively, for example. The cut-out surfaces formed by the cutting correspond to the cut-out portions 72b and 82b.

### Third Embodiment

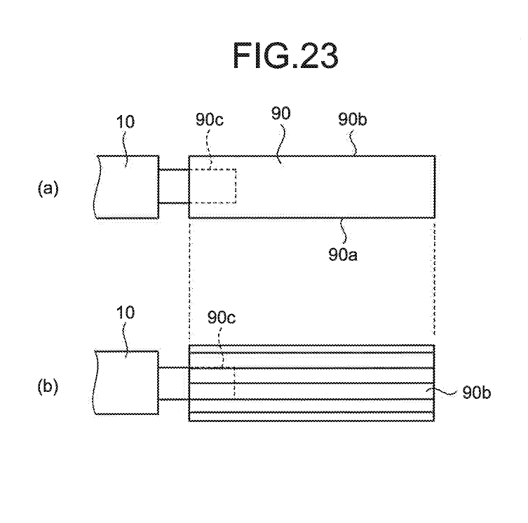

FIG. 22 is a sectional view of a connector according to a third embodiment of the present invention. FIG. 23 is a view schematically illustrating a structure of a terminal of the connector according to the third embodiment of the present invention. A connector 3 illustrated in FIGS. 22 and 23 has a structure including no base of the terminals according to the first and the second embodiments.

The connector 3 illustrated in FIG. 22 includes a terminal 90 extending into an approximately rod-shape, coupled to a conductor 10, and having conductivity, a terminal 100 extending into an approximately rod-shape, coupled to a conductor 20, and having conductivity, and a fixing member 35 that fixes the terminals 90 and 100 by covering the periphery of a contact part of the terminal 90 and the terminal 100 such that the terminal 90 and the terminal 100 are aligned in the direction extending into the rod-shape and overlap with each other in a direction perpendicular to the direction in which the terminals 90 and 100 are aligned. Similarly to the fixing member 32, the fixing member 35 is formed by curving a plate-shaped carbon tool steel or stainless steel into an approximately ring shape along the plate surface.

FIG. 23 includes a side view (a) and atop view (b) of the structure of the terminal 90 of the connector 3 according to the third embodiment. The terminal 90 is produced by cutting out the whole length of a conductive material formed in a rod-shape from an end opposite to the end coupled to the conductor 10 in the direction extending into the rod-shape. The terminal 90 has a sectional shape nearly the same as that of the contact portion 55 or the contact portion 65 illustrated in FIG. 17. The terminal 90 includes a peripheral portion 90a serving as a first peripheral portion, which is a peripheral surface (an arc part) of the rod, and a cut-out portion 90b serving as a first cut-out portion cut in a wave shape on a section along a direction perpendicular to the direction extending into the rod-shape. The terminal 90 also has a housing hole 90c forming an approximately columnar hollow space along the direction in which the terminal 90 extends and housing a plurality of power lines of the conductor 10 in the hollow space. A plurality of power lines 101 are pressed into the housing hole 90c and held by the housing hole 90c.

The terminal 100 has the same shape as that of the terminal 90. The terminal 100 has a sectional shape nearly the same as that of the contact portion 55 or the contact portion 65 illustrated in FIG. 19. The terminal 100 includes a peripheral portion 100a serving as a second peripheral portion, which is a peripheral surface (an arc part) of the rod, and a cut-out portion 100b serving as a second cut-out portion cut in a linear shape on a section along a direction perpendicular to the direction extending into the rod-shape. The terminal 100 also has a housing hole 100c forming an approximately columnar hollow space along the direction in which the terminal 100 extends and housing a plurality of power lines of the conductor 20 in the hollow space. The power lines of the conductor 20 are pressed into the housing hole 100c and held by the housing hole 100.

In the state where the terminals 90 and 100 are in contact with each other (overlap with each other), the outer-edge shape of the terminals 90 and 100 (peripheral portions 90a and 100a) on the section is a circle to figure having rotational symmetry through a rotation angle θ (0°<θ<360°, θ is a constant)).

The third embodiment brings two terminals having the same shape into contact with each other on respective parts having the same outer-edge shape on the section. This can increase the contact surface area to reduce the contact resistance between the terminals, thereby establishing stable and efficient electrical continuity. Because the third embodiment can provide a connector using the terminals having the same shape, it is not necessary to produce a male terminal and a female terminal individually as in the conventional technology. Thus, the third embodiment can also reduce a manufacturing process and manufacturing cost.

Furthermore, the third embodiment can bring the contact portions into contact with each other more easily and reliably with a simpler structure than the first and the second embodiments.

### INDUSTRIAL APPLICABILITY

As described above, the connector according to the present invention is useful to connect electronic members and the like and establish electrical continuity efficiently.

### REFERENCE SIGNS LIST

1, 2, 3 connector

10, 10a to 10c, 20, 20a to 20c conductor

11, 11a, 21, 51, 61, 71, 81, 90, 100 terminal

12, 22, 52, 62, 72, 82 contact portion

12a, 22a, 52a, 62a, 72a, 82a, 90a, 100a peripheral portion

12b, 22b, 52b, 62b, 72b, 82b, 90b, 100b cut-out portion

12c, 12d, 22c, 22d groove

13, 23, 53, 63 base

13a, 23a, 53a, 63a, 90c, 100c housing hole

31, 31a, 31b, 32, 33, 34, 35 fixing member

40 housing case

40a first housing case

40b second housing case

101 power line

1. A connector for being interposed between two connection objects and establishing electrical continuity between the two connection objects, the connector comprising:
a first terminal having conductivity and extending in a rod-shape, comprising a first peripheral portion serving as a peripheral surface of the rod-shape and a first cut-out portion obtained by cutting out whole or a part of the rod-shape from an end opposite to an end for being coupled to one of the two connection objects in a direction extending into the rod-shape;
a second terminal having conductivity and extending in a rod-shape, comprising a second peripheral portion serving as a peripheral surface of the rod-shape and a second cut-out portion obtained by cutting out whole or a part of the rod-shape from an end opposite to an end for being coupled to another one of the two connection objects in a direction extending into the rod-shape and having a same cut-out shape as that of the first cut-out portion on a section along a direction perpendicular to the direction extending into the rod-shape; and
a fixing member that fixes the first terminal and the second terminal by covering periphery of the first and the second terminals in a state where the first terminal and the second terminal are aligned in the direction extending into the rod-shape and overlap with each other in a direction perpendicular to the direction in which the first and the second terminals are aligned, wherein
the first cut-out portion faces the second peripheral portion or the second cut-out portion in the state where the first terminal and the second terminal overlap with each other, and at least parts of outer edges of a facing part have a same shape on the section along the direction perpendicular to the direction extending into the rod-shape.

2. The connector according to claim 1, wherein the first cut-out portion and the second cut-out portion make contact with each other in the state where the first terminal and the second terminal overlap with each other.

3. The connector according to claim 1, wherein the first cut-out portion has a linear shape or a convex-concave shape on the section along the direction perpendicular to the direction extending into the rod-shape.

4. The connector according to claim 1, wherein a sectional shape of the periphery formed of the first terminal and the second terminal of the facing part in the state where the first terminal and the second terminal overlap with each other is a figure having rotational symmetry through a rotation angle θ (0°<θ<360°, θ is a constant).

5. The connector according to claim 4, wherein the figure is a circle.

6. The connector according to claim 1, wherein
at least a part of an outer edge of the first cut-out portion on the section along the direction perpendicular to the direction extending into the rod-shape has a same shape as that of an outer edge of the second cut-out portion on the section, and
the first cut-out portion and the second peripheral portion make contact with each other in the state where the first terminal and the second terminal overlap with each other.

7. The connector according to claim 6, wherein the first cut-out portion or the first peripheral portion has a groove formed in the direction extending into the rod-shape on a surface thereof.

8. The connector according to claim 1, wherein the fixing member is formed of an elastic body that applies bias toward at least the facing part of the first terminal and the second terminal in a direction in which the first terminal and the second terminal overlap with each other.

9. The connector according to claim 1, wherein the first terminal and the second terminal have a same shape.
